(19) United States
(12) Patent Application Publication
(10) Pub. No.: US 2025/0145504 A1
(43) Pub. Date: May 8, 2025

(54) INTEGRATED WATER TREATMENT FOR WATER ELECTROLYSIS BY MEANS OF OSMOTIC MEMBRANE DISTILLATION

(71) Applicant: Fraunhofer-Gesellschaft zur Förderung der angewandten Forschung e.V., München (DE)

(72) Inventors: Thomas Schiestel, Stuttgart (DE); Tobias Götz, Stuttgart (DE); Christopher Hänel, Stuttgart (DE); Bentsian Elkin, Stuttgart (DE)

(21) Appl. No.: 18/730,188

(22) PCT Filed: Jan. 17, 2023
(86) PCT No.: PCT/EP2023/051037

§ 371 Date: Jul. 18, 2024

(30) Foreign Application Priority Data
Jan. 19, 2022 (DE) 10 2022 200 590.2

(51) Int. Cl. C02F 1/461; B01D 61/36; C02F 1/20; C02F 1/44; C25B 1/04; C25B 15/08

(52) U.S. Cl. CPC C02F 1/461; B01D 61/365; C02F 1/20; C02F 1/441; C02F 1/447; C25B 1/04; C25B 15/08; C02F 2001/46133; C02F 2209/02; C02F 2303/10

(57) ABSTRACT

The present invention relates to processes for electrolysis of water to generate hydrogen by means of osmotic membrane distillation plants, and to osmotic membrane distillation plants designed and suitable for such processes.

The present invention relates to processes for electrolysis of water to generate hydrogen by means of osmotic membrane distillation plants, and to osmotic membrane distillation plants designed and suitable for such processes.

Very pure water is required for the electrolysis of water to produce hydrogen, as otherwise its consumption will lead to an accumulation of the component parts it contains. This can lead to damage to the electrolysis plant and disrupt hydrogen generation.

In classic alkaline electrolysis, an aqueous KOH solution is electrochemically decomposed. Water is continuously consumed from the solution through the conversion to hydrogen and oxygen as well as through the resulting water vapour. This consumption must be continuously balanced in order to keep the electrolyte concentration in an optimal area. The selected conditions-concentration, temperature-represent a compromise between, preferably fast, kinetics and, preferably low, corrosion. If the water contains even traces of impurities, these will accumulate over time. Heat is generated by the loss voltages (overvoltage) resulting from electrolysis, so that the electrolyte solution must be actively cooled. As a rule, the hydrogen is required at a higher pressure. To avoid later compression, electrolysis is therefore carried out under pressure.

In principle, these statements also apply to other types of electrolysis, such as polymer electrolyte membrane or alkaline electrolyte membrane electrolysis.

In classic osmosis (forward osmosis (FO)), two solutions (for example aqueous salt solutions) of different osmolality are brought into contact via a semi-permeable, microscopically dense membrane. The adjusting osmotic pressure causes water to migrate through the membrane from the low osmolality side to the high osmolality side until the osmotic pressure is equalised on both sides without the water changing phase, wherein the salt ions are simultaneously retained. If the above-mentioned electrolyte solution (high osmolality) were brought into contact with a solution with a lower osmolality, for example seawater, via an FO membrane, the water would migrate from the seawater into the electrolyte solution.

However, the technical problem of providing water for electrolysis cannot be solved by means of FO membranes, as none of the membrane materials used to date—rather hydrophilic, highly cross-linked polymers such as polyamides—can withstand the harsh conditions of electrolysis mentioned above.

In membrane distillation (MD), two, in particular aqueous, solutions are brought into contact with each other via a porous, particularly hydrophobic, membrane. The membrane must be selected in such a way that the solutions cannot wet the membrane pores under the given conditions, while vapour molecules can penetrate the pores. If different vapour pressures are adjusted on both sides by controlling the temperature, molecules will migrate from the warm to the cold side of the membrane. This requires the water molecules to change from the liquid to the vapour phase. As only vaporisable components are transported, salts or other non-volatile impurities, especially organic compounds, remain on the warm side and the water can be purified by this process.

A major challenge with MD is the heat transport across the membrane, which reduces the driving force of the process and leads to considerable energy losses. In MD, there is always a fundamental conflict of objectives between high compound and low heat transport.

There are various procedurally approaches to reduce this problem, for example by avoiding direct contact (DCMD) of the solutions with the membrane and using a gas gap as “heat insulation” (Air Gap MD, Sweeping Gas MD, Permeate Gap MD).

However, the technical problem of providing water for electrolysis cannot be solved by means of membrane distillation, as the temperature of the electrolyte/permeate side is already high and therefore no driving force can be adjusted via the temperature.

Depending on the location and the water qualities available there, various established methods of water treatment are used to treat water for electrolysis of water, such as reverse osmosis, distillation, electrodialysis, capacitive deionisation or combinations of these processes, which, however, all have various disadvantages.

The technical problem underlying the present invention is to overcome the disadvantages of known processes for electrolysis of water to generate hydrogen. In particular, it is the technical problem of the present invention to provide a process which allows the process waste heat of electrolysis to be used for the purification of water for electrolysis and at the same time to control the temperature during electrolysis.

The present invention solves the underlying technical problem, in particular by the subject matter of the independent claims and the teachings of the dependent claims and the present description.

The invention relates to a process for electrolysis of water to generate hydrogen comprising the following process steps:
a) providing an electrolyte solution which comprises water and at least 1 mol/l of at least one electrolyte,
a feed solution comprising water, and
an osmotic membrane distillation plant which has at least three chambers, in particular a feed chamber, a permeate chamber and an electrolysis chamber, wherein the feed chamber and the permeate chamber are separated by a porous hydrophobic gas-permeable membrane and the feed chamber has feed solution and the permeate chamber has electrolyte solution,
b) carrying out an osmotic membrane distillation, wherein water evaporates in the feed chamber, passes through the membrane as water vapour and condenses into the electrolyte solution in the permeate chamber, and
c) electrolysing water of the electrolyte solution in the electrolysis chamber, wherein hydrogen and oxygen are obtained.

Accordingly, the invention provides a process in which hydrogen and optionally oxygen are generated from water by means of electrolysis. For this purpose, in a first process step a), an electrolyte solution is provided which comprises a minimum amount of at least one electrolyte, and a feed solution which has at least water, wherein the feed solution may also have one or more further substances.

Further, in process step a), an osmotic membrane distillation plant is provided which has at least three chambers, namely at least one feed chamber, at least one permeate chamber and at least one electrolysis chamber. The electrolysis chamber and permeate chamber have the same solution, namely the electrolyte solution, wherein the conditions in the two chambers, in particular the temperature and/or the pressure, may differ. The permeate chamber and feed chamber forming a membrane distillation unit, are separated by a porous hydrophobic gas-permeable membrane. This membrane ensures that the water in the feed solution can be transferred purified to the electrolyte solution, as only vaporisable components can be transported across the membrane because the hydrophobicity of the membrane prevents the solution from wetting the membrane. Therefore, salts or other non-volatile impurities, especially organic compounds, remain in the feed solution, which is thus concentrated. The water consumption in the electrolysis chamber is balanced by purifying the water in the feed solution.

Additionally, preferably a heat transport via the membrane from the electrolyte solution present in the permeate chamber to the feed solution present in the feed chamber can take place, which heats the feed solution and cools the electrolyte solution, which was heated in the electrolysis chamber by the electrolysis. At the same time, the transfer of heat from the electrolyte solution to the feed solution increases the water vapour pressure above the feed solution, which further promotes mass transport across the membrane. Therefore, the mass transport is improved at the same time as the temperature of the electrolyte solution is regulated.

The process according to the invention thus provides for carrying out an osmotic membrane distillation (OMD) in process step b). In a preferred embodiment, only the partial pressure difference caused by different water activity in the feed and electrolyte solution is utilised in process step b) for water transport through the porous hydrophobic membrane. Preferably, neither thermal processes alone are used to form the partial pressure difference, nor are pumps or compressors used for this purpose.

The process according to the invention thus provides in process step b) that water evaporates from the feed solution and passes through the membrane in the form of vapour and then condenses into the electrolyte solution in the permeate chamber.

The water purified in this way, which is now in the electrolyte solution in the permeate chamber, is transferred to the electrolysis chamber where it is split into hydrogen and oxygen by means of electrolysis.

In process step b), the process according to the invention thus provides for water to evaporate from the feed solution and pass through the membrane in the form of vapour and then condense again in the permeate chamber. The purified water, which is now in the permeate chamber, forms the electrolyte solution directly there, which is transferred to the electrolysis chamber where it is split into hydrogen and oxygen by means of electrolysis.

This introduces the advantage that a heat transport can take place via the membrane from the electrolyte solution present in the permeate chamber to the feed solution present in the feed chamber, which heats the feed solution and cools the electrolyte solution, which itself has been heated in the electrolysis chamber by the electrolysis. At the same time, the transfer of heat from the electrolyte solution to the feed solution increases the vapour pressure above the feed solution, which further promotes mass transport across the membrane. Therefore, the mass transport is improved at the same time as the temperature of the electrolyte solution is regulated.

The process according to the invention allows the waste heat from the electrolysis process to be utilised directly for purifying the water used for electrolysis. The heat transfer from the electrolyte solution to the feed solution made possible by the invention can be used on the one hand to heat the feed solution and thus increase the water flow. On the other hand, it can also be used to control the temperature of the electrolyte solution. Preferably, without taking electrolysis into account, a lower energy input is required for the membrane distillation itself.

Without being bound by theory, a preferred embodiment of the process according to the invention thus utilises the process waste heat from the electrolysis directly for purifying the water used for the electrolysis. This can preferably be done via the membrane or via a heat exchanger or preferably both. On the one hand, the heat transfer via the membrane and/or the heat exchanger is used to heat the feed solution and thus increase the water flow. On the other hand, it can also be used to control the temperature of the electrolyte solution. Preferably, apart from a low energy input for the pumps, no further energy is required for the membrane distillation itself, without taking electrolysis into account.

In a preferred embodiment of the invention, the electrolyte solution provided in process step a) comprises at least 5 mol/l, in particular at least 7 mol/l of at least one, in particular of an electrolyte.

In a preferred embodiment of the invention, the compound particle concentration in the electrolyte solution is higher than in the feed solution.

In a preferred embodiment of the invention, the water activity in the electrolyte solution is lower than in the feed solution.

In a preferred embodiment of the invention, the at least one electrolyte of the electrolyte solution provided in process step a) is at least one base, preferably a base.

In a preferred embodiment of the invention, the at least one electrolyte of the electrolyte solution provided in process step a) is at least one easily soluble base.

In a preferred embodiment of the invention, the at least one electrolyte of the electrolyte solution provided in process step a) is at least one organic base, in particular an organic base.

In a preferred embodiment of the invention, the at least one electrolyte of the electrolyte solution provided in process step a) is selected from the group consisting of KOH, NaOH, LiOH, RbOH, CsOH and combinations thereof.

In a preferred embodiment of the invention, the at least one electrolyte of the electrolyte solution provided in process step a) is KOH.

In a preferred embodiment of the invention, the feed solution provided in process step a) is a solution selected from the group consisting of groundwater, surface water, drinking water, waste water, brackish water, seawater and combinations thereof.

In a particularly preferred embodiment of the invention, the feed solution provided in process step a) is seawater.

In a preferred embodiment of the invention, the feed solution additionally comprises at least one additive, in particular an antiscalant.

In a particularly preferred embodiment of the invention, the feed solution additionally comprises at least one antiscalant, in particular a complexing agent, in particular ethylenediaminetetraacetate (EDTA).

In a particularly preferred embodiment, the one complexing agent is selected from the group consisting of ethylenediaminetetraacetate (EDTA), diethylenetriaminepentaacetate (DTPA, nitriloacetate (NTA), bifunctional or trifunctional carboxylic acid, in particular oxalic acid, tartaric acid or citric acid, or combinations thereof, in particular ethylenediaminetetraacetate (EDTA).

In a preferred embodiment, the feed solution has a lower osmolality than the electrolyte solution.

In a preferred embodiment, a higher water vapour pressure prevails above the feed solution in the feed chamber than above the electrolyte solution in the permeate chamber.

In a preferred embodiment of the invention, in process step a) and b), the temperature of the electrolyte solution is higher than the temperature of the feed solution.

In a preferred embodiment of the invention, the temperature of the electrolyte solution in process step a) is 70 to 90, in particular 75 to 85, in particular 78 to 82° C., in particular 80° C.

In a preferred embodiment of the invention, the temperature of the electrolyte solution in process step b) is 60 to 80, in particular 65 to 75, in particular 68 to 72° C., in particular 70° C.

In a preferred embodiment of the invention, the temperature of the feed solution in process step a) is 10 to 25, in particular 15 to 22, in particular 17 to 21° C., in particular 20° C.

In a preferred embodiment of the invention, the temperature of the feed solution in process step b) is 30 to 50, in particular 35 to 45, in particular 37 to 40° C., in particular 38° C.

In a preferred embodiment of the invention, the water vapour pressure prevailing above the electrolyte solution in the permeate chamber is at least 5 kPa, in particular at least 7 kPa.

In a preferred embodiment of the invention, the water vapour pressure prevailing above the feed solution in the feed chamber is at least 15 kPa, in particular at least 18 kPa.

In a preferred embodiment of the invention, the membrane distillation plant provided in process step a) has at least one, in particular one, heat exchanger. The at least one heat exchanger can preferably transport heat from the, in particular concentrated, electrolyte solution to the feed solution.

The at least one heat exchanger is preferably a parallel flow or counter flow heat exchanger.

In a particularly preferred embodiment, the at least one heat exchanger is located between the electrolysis chamber and the membrane distillation unit, in particular between the electrolysis chamber and the permeate chamber and in the inlet for the feed solution into the feed chamber.

In a preferred embodiment of the invention, the membrane distillation plant provided in process step a) has at least one heat exchanger, in particular between the electrolysis chamber and the permeate chamber and in the inlet for the feed solution into the feed chamber and/or integrated into the feed chamber and/or integrated into the electrolysis chamber and/or integrated into the permeate chamber.

In a particularly preferred embodiment, the at least one heat exchanger is integrated into the membrane distillation unit, in particular its permeate chamber, its feed chamber or both.

In a particularly preferred embodiment, the at least one heat exchanger is integrated into the electrolysis chamber.

In a particularly preferred embodiment, a heat exchanger is present between the electrolysis chamber and the membrane distillation unit, in particular between the electrolysis chamber and the permeate chamber and in the inlet for the feed solution into the feed chamber, and a further heat exchanger is integrated into the permeate chamber.

In a particularly preferred embodiment, a heat exchanger is present between the electrolysis chamber and the membrane distillation unit, in particular between the electrolysis chamber and the permeate chamber and in the inlet for the feed solution into the feed chamber, and a further heat exchanger is integrated into the electrolysis chamber.

In a particularly preferred embodiment, a heat exchanger is present between the electrolysis chamber and the membrane distillation unit, in particular between the electrolysis chamber and the permeate chamber and in the inlet for the feed solution into the feed chamber, and a further heat exchanger is integrated into the feed chamber.

In a particularly preferred embodiment, a heat exchanger is present between the electrolysis chamber and the membrane distillation unit, in particular between the electrolysis chamber and the permeate chamber and in the feed for the feed solution into the feed chamber, a further heat exchanger integrated into the permeate chamber and a further heat exchanger integrated into the feed chamber.

In a particularly preferred embodiment, a heat exchanger is present between the electrolysis chamber and the membrane distillation unit, in particular between the electrolysis chamber and the permeate chamber and in the feed for the feed solution into the feed chamber, a further heat exchanger is integrated into the permeate chamber and a further heat exchanger is integrated into the feed chamber and a further heat exchanger is integrated into the electrolysis chamber.

In a particularly preferred embodiment, a heat transfer in the heat exchanger located between the electrolysis chamber and the membrane distillation unit takes place from the concentrated electrolyte solution originating from the electrolysis chamber to feed solution which is directed into the feed chamber.

In a particularly preferred embodiment, a heat transfer in the heat exchanger in parallel flow located between the electrolysis chamber and the membrane distillation unit takes place from concentrated electrolyte solution originating from the electrolyte chamber to feed solution which is directed into the feed chamber.

In a particularly preferred embodiment, a heat transfer in the heat exchanger in counter flow located between the electrolysis chamber and the membrane distillation unit takes place from concentrated electrolyte solution originating from the electrolyte chamber to feed solution which is directed into the feed chamber.

In a particularly preferred embodiment, a heat transfer in the heat exchanger integrated in the feed chamber takes place from concentrated electrolyte solution originating from the electrolyte chamber to feed solution present in the feed chamber.

In a particularly preferred embodiment, a heat transfer in the heat exchanger integrated in the permeate chamber takes place from electrolyte solution present in the permeate chamber to fresh feed solution.

In a particularly preferred embodiment, a heat transfer in the heat exchanger integrated in the electrolysis chamber takes place from electrolyte solution present in the electrolysis chamber, in particular concentrated electrolyte solution, to fresh feed solution.

In a particularly preferred embodiment, at least one part of concentrated electrolyte solution and at least a portion of the feed solution is passed through the heat exchanger located between the electrolysis chamber and the membrane distillation unit. In a particularly preferred embodiment, the entire concentrated electrolyte solution and/or the entire feed solution is passed through the heat exchanger located between the electrolysis chamber and the membrane distillation unit.

In a preferred embodiment, one part of the concentrated electrolyte solution is transferred into the permeate chamber and the other part is passed through the heat exchanger located between the electrolysis chamber and the membrane distillation unit, wherein both parts are transferred back into the electrolysis chamber afterwards, preferably after combining the two parts.

In a preferred embodiment, one part of a concentrated electrolyte solution is transferred into the heat exchanger preferably located between the electrolysis chamber and the membrane distillation unit and afterwards into the permeate chamber and the other part is transferred into the heat exchanger preferably integrated into the feed chamber, wherein both parts are transferred back into the electrolysis chamber afterwards, preferably after combining the two parts. In a particularly preferred embodiment, at least one part of fresh feed solution is passed directly into the feed chamber and at least one part of the fresh feed solution is passed through the heat exchanger located between the electrolysis chamber and the membrane distillation unit.

In a particularly preferred embodiment, the entire fresh feed solution is passed through the heat exchanger located between the electrolysis chamber and the membrane distillation unit.

In a particularly preferred embodiment, the entire concentrated electrolyte solution is passed through the heat exchanger located between the electrolysis chamber and the membrane distillation unit.

In a preferred embodiment, a part of the electrolyte solution is passed directly into the permeate chamber and the other part is passed through the heat exchanger located between the electrolysis chamber and the membrane distillation unit.

In a preferred embodiment, a part of the fresh feed solution is passed into the heat exchanger located between the electrolysis chamber and the membrane distillation unit and the other part is passed into the heat exchanger integrated in the permeate chamber.

In a preferred embodiment, the fresh feed solution, which has been heated in a heat exchanger in an electrolysis chamber, is divided, wherein one part is guided into the permeate chamber and the other part is guided out of the plant.

In a preferred embodiment of the invention, the membrane distillation plant provided in process step a) has at least one, in particular one, throttle valve, which in particular regulates the pressure between the permeate chamber and the electrolysis chamber, preferably together with a pump.

In a preferred embodiment of the invention, the membrane distillation plant provided in process step a) has at least one, in particular one, pressure exchanger, which in particular regulates the pressure between the permeate chamber and the electrolysis chamber, preferably together with a pump.

In a preferred embodiment of the invention, the porous hydrophobic gas-permeable membrane between the feed chamber and the permeate chamber is configured in the form of a flat membrane, tubular membrane or hollow fibre membrane.

In a preferred embodiment of the invention, the electrolysis chamber is divided into two areas by a diaphragm, wherein the at least one anode and at least one cathode each are located in at least two different areas.

In a preferred embodiment, the permeate chamber and the electrolysis chamber of the membrane distillation plant provided in process step a) are connected by means of a line.

In a preferred embodiment of the invention, the porous hydrophobic gas-permeable membrane between the feed chamber and the permeate chamber has an average pore size of 0.05 to 0.9 μm, in particular 0.1 to 0.5 μm.

In a preferred embodiment of the invention, the porous hydrophobic gas-permeable membrane between the feed chamber and the permeate chamber is prepared from a hydrophobic polymer, in particular fluorine-containing polymers, in particular polyolefins or perfluorinated polyolefins, in particular polytetrafluoroethylene (PTFE), polyvinylidene fluoride (PVDF) or polypropylene (PP). The hydrophobic properties of the membrane are defined by the material used.

In a preferred embodiment of the invention, the porous hydrophobic gas-permeable membrane has a support. The support can mechanically stabilise the membrane.

In a particularly preferred embodiment of the invention, the support for the porous hydrophobic gas-permeable membrane is prepared from polysulphone, in particular polyethersulphone (PES).

In a particularly preferred embodiment of the invention, the porous hydrophobic gas-permeable membrane is prepared from PTFE and the support is prepared from polysulphone, in particular polyethersulphone (PES).

In a preferred embodiment of the invention, the membrane distillation plant provided in process step a) further has a device for removing carbon dioxide, which removes carbon dioxide from the feed solution before it reaches the feed chamber.

In a particularly preferred embodiment, the carbon dioxide is removed in the device for removing carbon dioxide by means of heating, flushing with another gas, in particular oxygen, by means of a membrane contactor, wherein an inert gas is present on the other side of the membrane, viewed from the side with feed solution, precipitates in the form of carbonate or combinations thereof.

In a preferred embodiment, the membrane distillation plant provided in process step a) further has at least one filtration unit. In a particularly preferred embodiment, the at least one filtration unit is located in the inlet for the feed solution into the feed chamber.

In a preferred embodiment of the invention, the osmotic membrane distillation according to process step b) is a direct contact, air gap, vacuum or sweeping gas membrane distillation.

In a preferred embodiment of the invention, the distillation rate of the water from the feed chamber via the porous hydrophobic gas-permeable membrane into the permeate chamber is at least 1 kg m⁻² h⁻¹, in particular at least 2 kg m⁻² h⁻¹, in particular 2.5 kg m⁻² h⁻¹.

In a preferred embodiment of the invention, a temperature of at least 60° C., in particular at least 70° C., in particular at least 80° C., is present during the electrolysis in process step c).

In a preferred embodiment of the invention, a temperature of 60 to 100° C., in particular 70 to 90° C., in particular 75 to 85° C., in particular 80° C., is present during the electrolysis in process step c).

In a preferred embodiment of the invention, a temperature of more than 60° C. and lower than the boiling point of the electrolyte solution used is present during the electrolysis in process step c).

In a preferred embodiment of the invention, a pressure of 1 to 70 bar, in particular 2 to 70 bar, in particular 1 to 60 bar, in particular 1 to 5 bar, in particular 6 to 60 bar, in particular 5 bar, in particular 60 bar, is present during the electrolysis in process step c).

In a preferred embodiment of the invention, a current density of 0.5 to 2, in particular 1 A/cm², is used in the electrolysis in process step c).

In a preferred embodiment of the invention, the electrolysis in process step c) is a polymer electrolyte membrane electrolysis, in particular a proton exchange membrane (PEM) electrolysis or anion exchange membrane (AEM) electrolysis, or alkaline electrolysis, preferably an alkaline electrolysis with a diaphragm.

In a preferred embodiment of the invention, the process additionally comprises the following process step d): subsequent feeding of further feed solution into the feed chamber, wherein concentrated feed solution is withdrawn from the feed chamber.

In a particularly preferred embodiment of the invention, the concentrated feed solution withdrawn in process step d) is used in a pressure-retarded osmosis process to generate energy.

The present invention also relates to an osmotic membrane distillation plant which is designed for a process according to the invention, wherein the plant has at least three chambers, in particular a feed chamber, a permeate chamber and an electrolysis chamber, wherein the feed chamber and permeate chamber are separated by a porous hydrophobic gas-permeable membrane and the electrolysis chamber is connected to the permeate chamber.

In a particularly preferred embodiment of the invention, electrolyte solution is present in the permeate chamber and the electrolysis chamber.

The present invention also relates to an osmotic membrane distillation plant which is characterised in particular by the features disclosed above in connection with the present method according to the invention, in particular device features, in particular heat exchangers.

In the context of the present invention, an “electrolyte solution” is understood to mean a, preferably aqueous, solution which comprises at least one electrolyte, in particular one, in particular two electrolytes.

In the context of the present invention, a “feed solution” is understood to mean an aqueous solution which comprises water. In addition to water, the solution may comprise further substances, dissolved and/or undissolved.

In the context of the present invention, a membrane distillation unit is understood to mean a device which has at least one, in particular one, feed chamber and at least one, in particular one, permeate chamber, wherein the feed chamber and the permeate chamber are separated by at least one porous hydrophobic gas-permeable membrane.

In the context of the present invention, “osmotic membrane distillation” (OMD) is understood to mean a process in which, by evaporation of water and transfer of water vapour formed thereby through a porous hydrophobic membrane, changes in the solution concentration of two solutions separated by the porous hydrophobic membrane (feed solution and target solution, wherein the target solution is the electrolyte solution) are achieved and wherein the driving force causing these changes is the partial pressure difference between the solutions separated by the membrane, which is caused by different compound particle concentrations in the feed and target solutions. Accordingly, there is necessarily a lower water activity, thus, a higher compound particle concentration, in the electrolyte solution than in the feed solution.

In the context of the present invention, a membrane distillation plant is understood to mean a device which has at least one membrane distillation unit and at least one electrolysis chamber, which are fluidically connected to one another via lines, and which preferably has at least one heat exchanger, at least one pump, a device for CO₂ removal and/or valves as well as inlet, connection and/or discharge lines.

In the context of the present invention, a “feed chamber” is understood to mean an area of a membrane distillation plant which has feed solution and which is directly adjacent to a permeate chamber, wherein it is separated from the permeate chamber by a porous hydrophobic gas-permeable membrane. The chamber may further comprise at least one inlet and at least one outlet, wherein fresh feed solution flows from an inlet for the feed solution into the feed chamber via the inlet and concentrated feed solution leaves the feed chamber via the outlet. The feed chamber may also have an integrated heat exchanger.

In the context of the present invention, an “inlet for the feed solution into the feed chamber” is understood to mean a line system which is capable of passing fresh feed solution, in particular from a feed solution source, for example a tank or a body of water, into the feed chamber. A filtration unit can be integrated in the “inlet for the feed solution into the feed chamber” in order to separate undissolved components.

In the context of the present invention, a “permeate chamber” is understood to mean an area of a membrane distillation plant which has electrolyte solution and which is directly adjacent to a feed chamber, wherein it is separated from the feed chamber by a porous hydrophobic gas-permeable membrane. The permeate chamber is further connected to the electrolysis chamber, in particular via a line, and electrolyte solution can flow from the permeate chamber, enriched with purified water from the feed solution, into the electrolyte chamber and can flow concentrated from the electrolyte chamber, preferably via a line, back to the permeate chamber. Different conditions, in particular different temperatures and/or pressures, may prevail in the permeate chamber compared to the electrolysis chamber. The permeate chamber may also have an integrated heat exchanger.

In the context of the present invention, an “electrolysis chamber” is understood to mean an area of a membrane distillation plant which is used for the electrolysis of water of an electrolyte solution. It has at least one anode and at least one cathode, wherein the electrodes can optionally be separated by a membrane/diaphragm. According to the invention, the electrolysis chamber is connected to the permeate chamber of the membrane distillation unit, in particular via a line, wherein electrolyte solution, enriched with purified water from the feed solution, flows from the permeate chamber into the electrolysis chamber and concentrated electrolyte solution flows from the electrolysis chamber into the permeate chamber. Different conditions, in particular different temperatures and/or pressures, may prevail in the electrolysis chamber compared to the permeate chamber. In the electrolysis chamber, electrolysis of water into hydrogen and oxygen is carried out. The electrolysis chamber may also have an integrated heat exchanger.

In the context of the present invention, an “antiscalant” is understood to mean an additive which reduces and/or prevents the precipitation of salts, in particular poorly soluble salts, and thus the deposition of particles on a membrane surface.

In the context of the present invention, a “concentrated feed solution” is understood to mean a feed solution in which, as a result of osmotic membrane distillation, in particular vapour pressure membrane distillation, the amount of water in the solution has been reduced and, at the same time, the concentration of substances dissolved and/or undissolved therein has been increased.

In the context of the present invention, a “concentrated electrolyte solution” is understood to mean an electrolyte solution in which, as a result of electrolysis, the amount of water has been reduced by the gases generated by electrolysis and/or water vapour formed and, at the same time, the concentration of dissolved at least one electrolyte has been increased.

In the context of the present invention, a “fresh feed solution” is understood to mean a feed solution which has not yet been subjected to a process step b) according to the invention and/or a heat exchange step, in particular which has neither been concentrated nor heated.

In the context of the present invention, the term “at least one” is understood to mean a quantity expressing a number of 1 or 2 or 3 or 4 or 5 or 6 or 7 or 8 or 9 or 10 and so on. In a particularly preferred embodiment, the term “at least one” may represent exactly the number 1. In a further preferred embodiment, the term “at least one” may also mean 2 or 3 or 4 or 5 or 6 or 7.

Where quantitative data, in particular percentages, of components of a product or a composition are given in the context of the present invention, these add up to 100% of the composition and/or the product together with the other explicitly stated or evident for a person skilled in the art further components of the composition or the product, unless explicitly stated otherwise or evident for a person skilled in the art.

Where, in the context of the present invention, a “presence”, a “containing”, a “having” or a “content” of a component is explicitly mentioned or implied, this means that each component is present, in particular is present in a measurable amount.

If, in the context of the present invention, a “presence”, a “containing” or a “having” of a component in an amount of 0 [unit], in particular mg/kg, μg/kg or wt. %, is expressly mentioned or implied, this means that the respective components are not present in a measurable amount, in particular are not present.

The number of decimal places indicated corresponds to the precision of the measurement method used in each case.

In the context of the present invention, the term “and/or” is understood to mean that all members of a group which are connected by the term “and/or” are disclosed both alternatively to each other and cumulatively to each other in any combination. This means for the expression “A, B and/or C” that the following disclosure content is to be understood: a) A or B or C or b) (A and B), or c) (A and C), or d) (B and C), or e) (A and B and C).

In the context of the present invention, the terms “comprising” and “having” are understood to mean that additionally to the elements explicitly covered by these terms, further elements not explicitly mentioned may be added. In the context of the present invention, these terms are also understood to mean that only the explicitly mentioned elements are included and that no further elements are present. In this particular embodiment, the meaning of the terms “comprising” and “having” is synonymous with the term “consisting of”. Furthermore, the terms “comprising” and “having” also encompass compositions which, in addition to the explicitly mentioned elements, also contain further elements which are not mentioned but which are of a functional and qualitatively subordinate nature. In this embodiment, the terms “comprising” and “having” are synonymous with the term “consisting essentially of”. The term “consisting of” means that only the explicitly mentioned elements are present and the presence of further elements is excluded.

Further embodiments of the present invention are the objects of the subclaims and further independent claims.

The invention is explained in more detail with reference to the following examples and the associated figures.

The figures show:

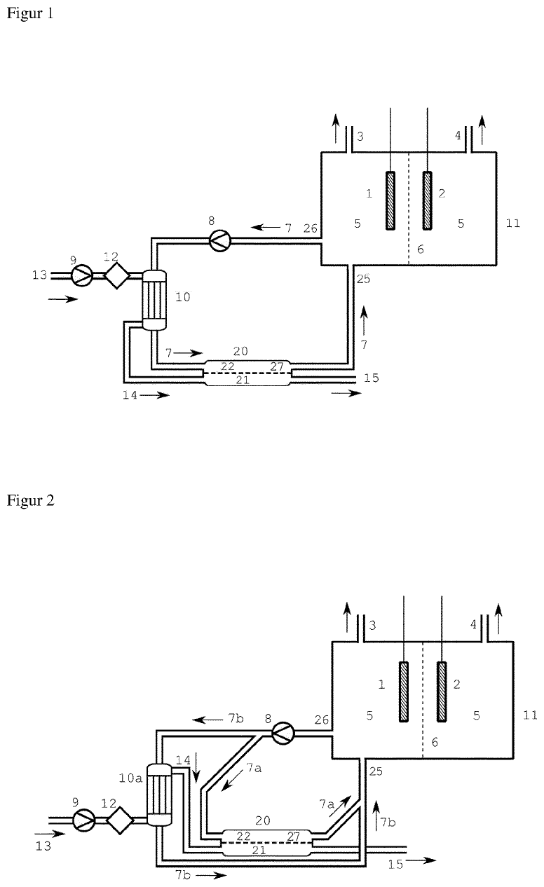

FIG. 1 a schematic drawing of a membrane distillation plant according to the invention with a feed chamber, a permeate chamber, both of which, together with the porous hydrophobic membrane arranged between the two chambers, form a membrane distillation unit, and an electrolysis chamber. A parallel flow heat exchanger, which is arranged between the electrolysis chamber and the permeate chamber and in the inlet for the feed solution into the feed chamber, transports heat from the concentrated electrolyte solution to the feed solution. Further, the plant has a device for removing CO₂ and water pumps for transporting the feed solution and electrolyte solution. The anode and cathode are separated by a diaphragm in the electrolysis chamber.

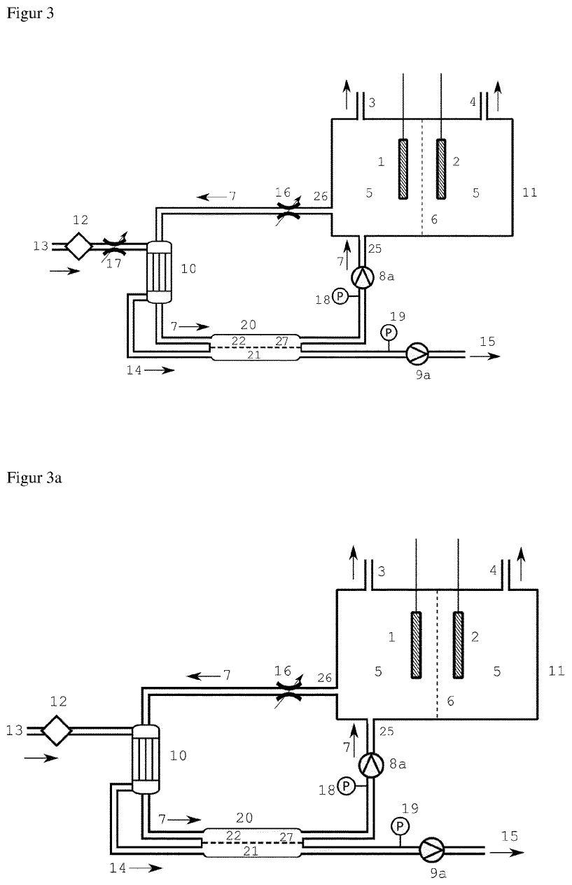

FIG. 2 a schematic drawing of a membrane distillation plant according to the invention with a feed chamber, a permeate chamber and an electrolysis chamber. A counter flow heat exchanger transports heat from the concentrated electrolyte solution to the feed solution. According to the present embodiment, the flow of the concentrated electrolyte solution is divided after the electrolysis chamber, wherein the first part of the electrolyte solution is used to heat the feed solution before it is fed into the MD unit and the second part flows into the permeate chamber. Further, the plant has a device for removing CO₂ and water pumps for transporting the feed solution and electrolyte solution. The anode and cathode are separated by a diaphragm in the electrolysis chamber.

FIG. 3 a schematic drawing of a membrane distillation plant according to the invention with a feed chamber, a permeate chamber and an electrolysis chamber. A parallel flow heat exchanger and the membrane between the feed chamber and the permeate chamber transport heat from the concentrated electrolyte solution to the feed solution. The plant also has throttle valves and water pumps to create a negative pressure in the feed and permeate chamber and thus increase the distillation rate. Furthermore, the plant also a device for removing CO₂. The anode and cathode are separated by a diaphragm in the electrolysis chamber.

FIG. 3a a schematic drawing of a membrane distillation plant according to the invention with a feed chamber, a permeate chamber and an electrolysis chamber. A parallel flow heat exchanger and the membrane between the feed chamber and the permeate chamber transport heat from the concentrated electrolyte solution to the feed solution. The plant further has a throttle valve in the line from the electrolysis chamber to the heat exchanger and water pumps to create an overpressure in the electrolysis chamber. Furthermore, the plant has a device for removing CO₂. The anode and cathode are separated by a diaphragm in the electrolysis chamber.

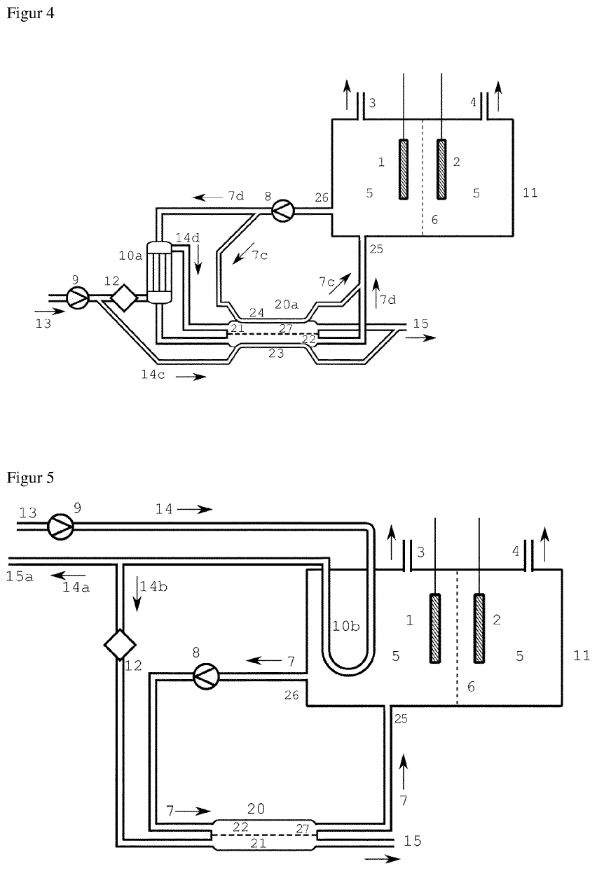

FIG. 4 a schematic drawing of a membrane distillation plant according to the invention with a feed chamber, a permeate chamber and an electrolysis chamber. A counter flow heat exchanger, which is arranged between the electrolysis chamber and the permeate chamber and in the inlet for the feed solution into the feed chamber, transports heat from the concentrated electrolyte solution to the feed solution. The concentrated electrolyte solution from the electrolysis chamber is divided into two lines and fed into the permeate chamber via the heat exchanger on the one hand and into a heat exchanger integrated into the feed chamber on the other. The two flows then merge and reach the electrolysis chamber again after enrichment with water from the feed chamber. In addition to the heat transfer in the heat exchanger between the electrolysis chamber and the membrane distillation plant, heat is transferred to the heat exchanger in the feed chamber by a separate supply of concentrated electrolyte solution. By a separate supply of fresh feed solution in a separate feed, thus, a separate line, into a further heat exchanger in the permeate chamber heat is transferred from the permeate chamber into this fresh feed solution and dissipated. Further, the plant has a device for removing CO₂ and water pumps for transporting the feed solution and electrolyte solution. The anode and cathode are separated by a diaphragm in the electrolysis chamber.

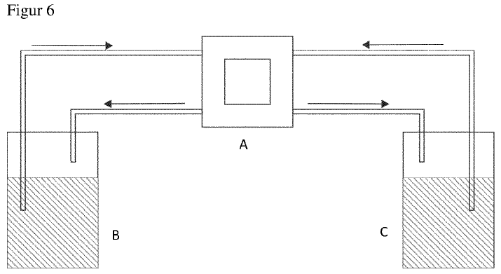

FIG. 5 is a schematic drawing of a membrane distillation plant according to the invention with a feed chamber, a permeate chamber and an electrolysis chamber. A heat exchanger integrated into the electrolysis chamber transports heat from the electrolyte solution to fresh feed solution. The flow of the feed solution is divided after the heat exchanger, wherein the first part of the feed solution is disposed of via an outlet and the second part flows into the feed chamber. Further, the plant has a device for removing CO₂ and water pumps for transporting the feed solution and electrolyte solution. The anode and cathode are separated by a diaphragm in the electrolysis chamber.

FIG. 6 is a schematic drawing of an experimental set-up for determining the distillation rate across a membrane in a membrane distillation unit with feed chamber, permeate chamber and hydrophobic, porous membrane.

### LIST OF REFERENCE SIGNS

1 Anode
2 Cathode
3 Oxygen gas extraction
4 Hydrogen gas extraction
5 Electrolyte
6 Diaphragm
7 Flow of electrolyte solution
7a Flow of electrolyte solution, branched off to the membrane distillation unit
7b Flow of electrolyte solution, branched off to the heat exchanger
7c Flow of electrolyte solution, branched off for heating the membrane distillation unit
7d Flow of electrolyte solution, branched off via heat exchanger to the membrane distillation unit
8 Electrolyte solution pump
8a Electrolyte solution pump in suction operation
9 Water pump
9a Water pump in suction operation
10 Heat exchanger in parallel flow operation
10a Heat exchanger in counter flow operation
10b Heat exchanger integrated in the electrolysis chamber
11 Electrolyte chamber
12 Device for CO₂ removal
13 Water inlet
14 Flow of the Water
14a Flow of the water, branched off after the integrated heat exchanger to the water outlet 15a
14b Flow of the water, branched off after the integrated heat exchanger and fed to the MD unit
14c Flow of the water, branched off to cool the membrane distillation unit
14d Flow of the water, branched off via heat exchanger to the membrane distillation unit
15,15a Water outlet
16 Throttle valve for electrolyte solution
17 Throttle valve for water
18,19 Pressure sensors
20 Membrane distillation unit (MD unit)
20a Air gap MD unit
21 Feed chamber
22 Permeate chamber
23, 24 Built-in heat exchanger of the membrane distillation unit
25 Inlet electrolysis chamber
26 Outlet electrolysis chamber
27 Porous hydrophobic gas-permeable membrane between permeate chamber and feed chamber

### EXAMPLES

### Embodiment Example 1

A schematic drawing of the membrane distillation plant according to embodiment example 1 can be found in FIG. 1.

The fresh feed solution, in the present case seawater, from the inlet 13 is conveyed by means of the pump 9. The solution passes through the CO₂ removal device 12, then through the parallel flow heat exchanger 10, through the membrane distillation unit 20, in particular through the feed chamber 21, and is discharged from the outlet 15 (see flow 14 in FIG. 1).

The electrolyte solution 5, in the present example a concentrated alkaline solution, namely 40 wt. % KOH solution (7 M) in water, is withdrawn from the electrolysis chamber 11 by means of pump 8. The solution passes through the heat exchanger 10, through the membrane distillation unit 20, in particular through the permeate chamber 22, and is then fed back into the electrolysis chamber 11 (see flow 7 in FIG. 1).

In the present embodiment example, the electrolysis chamber 11 is divided by means of a diaphragm 6 into two areas, an area with an anode 1, an oxygen gas extraction opening 3 and an inlet 25 for electrolyte solution and an outlet 26 for concentrated electrolyte solution, and an area with a cathode 2 and a hydrogen gas extraction opening 4. It is also possible that the cathode 2 and the hydrogen gas extraction opening 4 are located on the side with the inlet 25 and outlet 26 and the anode 1 and the oxygen gas extraction opening 3 are located on the other side of the diaphragm.

In the parallel flow heat exchanger 10, the two compound flows, thus, seawater and electrolyte solution, are brought to approximately the same temperature, which is between the working temperature in the electrolysis chamber (in the present embodiment example around 80° C.) and the ambient temperature. The temperature at the outlet of the heat exchanger 10 can be regulated by the ratio between the two mass flows. This temperature is optimised to a compromise between the distillation rate, which increases as the temperature rises, and the stability of the membrane 27 in the chemically aggressive lye, which must be taken into account at higher temperatures.

In the membrane distillation unit 20, the transfer of water takes place in the form of vapour from the feed chamber 21 towards the electrolyte solution 5 in the permeate chamber 22. As distillation takes place under almost isothermal conditions in this embodiment, the driving force is predominantly osmotic in nature: the activity of the water or its vapour pressure is clearly lower in the electrolyte solution 5 than in the water in the feed solution. At 60° C., the saturated vapour pressure of the water is approximately 145 Torr (approximately 19 kPa), while for 40 wt. % KOH solution this value is only approximately 55 Torr (approximately 7 kPa).

The water transferred to the electrolyte solution 5 compensates for the water consumption caused both by the conversion of the water into hydrogen and oxygen and by the losses due to evaporation in the electrolysis chamber 11. The distillation process guarantees the high purity of the water introduced, which is very important for the continuous operation of the electrolysis chamber.

At the same time, waste heat from the process is removed from the electrolysis chamber because the electrolyte solution fed back in has a lower temperature.

### Embodiment Example 2

A schematic drawing of the membrane distillation plant according to embodiment example 2 can be found in FIG. 2.

The main difference compared to embodiment example 1 is that the temperature of the distillation process and thus the process rate can be optimised by means of a counter flow heat exchanger 10a.

The concentrated electrolyte solution 5 withdrawn from the electrolysis chamber 11 is divided into two partial flows 7a and 7b. The partial flow 7b is fed into the counter flow heat exchanger 10a and brings the water temperature of the fresh feed solution in the counter flow to almost the original temperature of the electrolyte solution 5 in the electrolysis chamber 11, which is around 80° C., so that the feed chamber 21 is supplied with hot feed solution in the feed flow 14. This hot water is fed into the MD unit 20, in particular the feed chamber 21, as feed solution. The branched off partial flow 7a of the electrolyte solution 5 is introduced into the permeate chamber 22 of the membrane distillation unit 20 and enriched with water from the feed chamber 21 transferred via the vapour phase. In this embodiment, the distillation process takes place as in embodiment example 1, thus, under almost isothermal conditions, but at a significantly higher temperature and therefore has a higher process rate.

The partial flows of electrolyte 7a and 7b are then fed back into the electrolysis chamber 11 after being combined. As in embodiment example 1, the water is, thus, fed into the electrolysis chamber 11 and the waste heat is discharged.

### Embodiment Example 3

A schematic drawing of the membrane distillation plant according to embodiment example 3 can be found in FIG. 3. This plant essentially corresponds to that of FIG. 1 (embodiment example 1), to the description of which reference is made.

In this embodiment example, however, distillation is carried out at a lower pressure than vacuum membrane distillation. For this purpose, the pumps 8a and 9a are used in suction operation and the flow of the electrolyte solution 5 is limited by means of the throttle valves 16 and 17, whereby a negative pressure is created. The negative pressure is detected by means of sensors 18 and 19. The pressure regulation can be made in a feedback loop both by adjusting the pump output and by regulation of the throttle valves.

Instead of the negative pressure creation by means of throttle valves, a pressure exchanger can also be used as an option.

### Embodiment Example 3a

In a further embodiment example as a variation of embodiment example 3 (see FIG. 3a), electrolysis is carried out under increased pressure, for example as medium-pressure electrolysis at 5 bar or as high-pressure electrolysis at 60 bar. The throttle valve 16 and the pump 8a are used to reduce the pressure of the electrolyte solution in the membrane distillation unit to approximately atmospheric pressure. Instead of reducing the pressure by means of a throttle valve, a pressure exchanger can also be used as an option. In this case, the creation of negative pressure in the feed circuit and thus the throttle valve 17 can be dispensed with.

### Embodiment Example 4

A schematic drawing of the membrane distillation plant according to embodiment example 4 can be found in FIG. 4.

In this embodiment, distillation is carried out under non-isothermal conditions. As in Example 2 and FIG. 2, a counter flow heat exchanger 10a is used to lower the temperature of the electrolyte solution 5 and raise the temperature of the feed solution. The two flows 7d and 14d are then fed into the membrane distillation unit 20a. The temperature difference maximises the process rate and the process is a combination of conventional and osmotic membrane distillation. The latent heat of evaporation or condensation results in a considerable heat transfer from the feed side to the permeate side, which would quickly equalise the temperature difference. To avoid this, each chamber of the distillation unit 20a is additionally cooled or heated using the built-in heat exchangers 23 and 24. Fresh, thus, cold, feed solution 14c (heat exchanger 23 integrated in permeate chamber 22) can be used as the cooling medium, while the branched off hot electrolyte solution 7c (heat exchanger 24 integrated in feed chamber 21) can be used as the heating medium.

The membrane distillation unit 20a can advantageously be effected as a so-called air gap membrane distillation unit. The air gap minimises the undesirable additional heat transfer between the feed and permeate side caused by the thermal conductivity of the membrane 27. If the Air Gap MD unit is constructed in such a way that the air gap is located between the membrane 27 and the electrolyte solution 5, direct contact between the membrane 27 and the lye and the associated membrane stability problems are avoided.

### Embodiment Example 5

A schematic drawing of the membrane distillation plant according to embodiment example 5 can be found in FIG. 5.

The main difference compared to embodiment example 1 is that the temperature of the feed solution is brought to almost the temperature of the electrolyte solution 5 in the electrolysis chamber 11 by means of a heat exchanger 10b integrated into the electrolysis chamber. The electrolyte solution is cooled directly in the electrolytic chamber by the integrated heat exchanger 10b. After the heat exchanger, the feed flow is divided into two partial flows 14a and 14b. The partial flow 14a of the feed solution, which is not required for membrane distillation due to the quantity, is removed from the membrane distillation plant and thus from the process via the outlet 15a.

In the partial flow 14b, the device for CO₂ removal 12 is positioned upstream of the feed chamber 21. The carbon dioxide removal can be optimised by the increased temperature of the feed solution.

The membrane distillation takes place under almost isothermal conditions at almost the original temperature of the electrolyte solution 5.

### Embodiment Example 6

In FIG. 6 a membrane distillation unit 20 is shown. In this embodiment example, the distillation rate of water from a feed solution (B) to an electrolyte solution (C) was determined within a membrane distillation unit (A), with not shown one feed chamber and permeate chamber each, across a porous hydrophobic gas-permeable membrane with an average pore size of 100 nm, wherein the membrane was prepared from PTFE and had a carrier of polysulphone, in particular polyethersulphone (PES). For this purpose, feed solution and electrolyte solution were added to a membrane distillation unit of storage containers by means of peristaltic pumps and the mass increase in the electrolyte solution was determined after 3 hours.

### Conditions

Feed (feed solution): Ultrapure water (0.8 mS cm-1)
Draw (electrolyte solution): 4 M KCl (corresponds to 4 M KOH, since ionic strength is the same)
Gravimetric determination of the mass increase in electrolyte solution/draw solution (before and after measurement)
Circulation via peristaltic pumps (30 rpm)
Measuring time 3 h

### Result:

Water flow across the membrane: 2.6 kg/m² h

As a result, a distillation rate of 2.6 kg/m² h was measured across the membrane.

1. A process for electrolysis of water to generate hydrogen comprising the following process steps:
a) providing an electrolyte solution (5) which comprises water and at least 1 mol/l of at least one electrolyte,
a feed solution comprising water, and
an osmotic membrane distillation plant which has at least three chambers, in particular a feed chamber (21), a permeate chamber (22) and an electrolysis chamber (11), wherein the feed chamber (21) and the permeate chamber (22) are separated by a porous hydrophobic gas-permeable membrane (27) and the feed chamber (21) has feed solution and the permeate chamber (22) has electrolyte solution (5),
b) carrying out an osmotic membrane distillation, wherein water evaporates in the feed chamber (21), passes through the membrane (27) as water vapour and condenses into the electrolyte solution in the permeate chamber (22), and
c) electrolysing water of the electrolyte solution (5) in the electrolysis chamber (11), wherein hydrogen and oxygen are obtained.

2. The process of claim 1, wherein the membrane distillation plant provided in process step a) has at least one heat exchanger (10, 10a), in particular between electrolysis chamber (11) and permeate chamber (22) and/or integrated into the feed chamber (21) and/or integrated into the electrolysis chamber (11) and/or integrated into the permeate chamber (22) or a combination thereof.

3. The process of claim 1, wherein the membrane distillation plant provided in process step a) has at least one pressure exchanger.

4. The process of claim 1, wherein the porous hydrophobic gas-permeable membrane (27) is configured in the form of a flat membrane, tubular membrane or hollow fibre membrane.

5. The process of claim 1, wherein the membrane distillation plant provided in process step a) further comprises a device for removing carbon dioxide (12), which removes carbon dioxide from the feed solution before it reaches the feed chamber.

6. The process of claim 1, wherein the feed solution provided in process step a) is a solution selected from the group consisting of groundwater, surface water, drinking water, waste water, brackish water, seawater and combinations thereof.

7. The process of claim 1, wherein the feed solution has a lower osmolality than the electrolyte solution (5).

8. The process of claim 1, wherein the feed solution provided in a process step a) additionally comprises at least one antiscalant.

9. The process of claim 1, wherein the osmotic membrane distillation according to process step b) is a direct contact, air gap, vacuum or sweeping gas membrane distillation.

10. The process of claim 1, wherein the distillation rate of the water from the feed chamber (21) via the porous hydrophobic membrane (27) into the permeate chamber (22) is at least 1 kg m⁻² h⁻¹.

11. The process of claim 1, wherein a temperature of at least 60° C. is present during the electrolysis in process step c).

12. The process of claim 1, wherein the electrolysis in process step c) is a polymer electrolyte membrane electrolysis, in particular a proton exchange membrane (PEM) electrolysis or anion exchange membrane (AEM) electrolysis, or alkaline electrolysis, preferably an alkaline electrolysis with diaphragm.

13. The process of claim 1, wherein the process additionally comprises the following process step: d) subsequent feeding of further feed solution into the feed chamber (21), wherein concentrated feed solution is withdrawn from the feed chamber (21).

14. The process of claim 13, wherein the concentrated feed solution withdrawn in process step d) is used in a pressure-retarded osmosis process to generate energy.

15. An osmotic membrane distillation plant which is designed for a process according to claim 1, wherein the plant has at least three chambers, in particular a feed chamber (21), a permeate chamber (22) and an electrolysis chamber (11), wherein the feed chamber (21) and permeate chamber (22) are separated by a porous hydrophobic gas-permeable membrane (27) and the electrolysis chamber (11) is connected to the permeate chamber (22).
